(19) United States
(12) Patent Application Publication
(10) Pub. No.: US 2013/0234400 A1
(43) Pub. Date: Sep. 12, 2013

(54) PISTON RING

(71) Applicants: Akira Iijima, Fujisawa-shi (JP); Hirokazu Murata, Saitama-shi (JP); Michihiro Ito, Saitama-shi (JP)

(72) Inventors: Akira Iijima, Fujisawa-shi (JP); Hirokazu Murata, Saitama-shi (JP); Michihiro Ito, Saitama-shi (JP)

(73) Assignee: NIPPON PISTON RING CO., LTD., Saitama (JP)

(21) Appl. No.: 13/883,897

(22) PCT Filed: Nov. 15, 2011
(86) PCT No.: PCT/JP2011/076242

§ 371 Date: May 7, 2013

(30) Foreign Application Priority Data
Nov. 18, 2010 (JP) 2010-257540

(51) Int. Cl. F16J 9/12; F16J 9/26

(52) U.S. Cl. CPC F16J 9/12; F16J 9/26
USPC 277/459

(57) ABSTRACT

A piston ring reduces reciprocating friction between a piston and an inner wall surface of a cylinder, while maintaining reduction effect of the reciprocating friction. The piston ring is mounted in a ring groove of the piston, and slides against the inner wall surface of a cylinder liner or a cylinder. The piston ring includes: plural fine recessed portions formed in a barrel width region on an outer peripheral sliding surface of the piston ring; and a non-recessed portion area where no recessed portions are formed in the barrel width region. The non-recessed portion area is configured to have an area percentage within a range from 20-85% in the barrel width region where an area percentage of the barrel width region before the recessed portions are formed is defined to be 100%. The non-recessed portion area exists through an entire cross section in an axial direction of the barrel width.

### TECHNICAL FIELD

The present invention relates to a low-friction piston ring for an internal combustion engine that slides against an inner wall surface of a cylinder liner or a cylinder.

### BACKGROUND ART

Environmental problems represented by global warming have been closed up on a global scale, and it has been a crucial issue to develop technologies to improve fuel consumption of internal combustion engines for the purpose of reduction of CO₂ in the atmosphere. As one of the technologies to improve fuel consumption, it has been desired to reduce friction loss of sliding members for use in engines and others. In the light of this fact, there have been developed various techniques pertinent to material, surface treatment and reforming of sliding members excellent in wear resistance and scuffing resistance, and achieves maximum effect of friction reduction.

It is effective to reduce friction loss in order to enhance energy efficiency of an apparatus having a cylinder, such as improvement of fuel consumption of an internal combustion engine. Particularly, it is effective to reduce friction between an outer peripheral sliding surface of a piston ring that reciprocatingly moves and an inner wall surface of a cylinder liner or a cylinder. In order to reduce friction force between a piston ring and a cylinder liner, it can be considered to reduce tension of the piston ring. There is, however, a problem that reduction of tension of the piston ring may cause deterioration of sealing performance, and thus cause increase in consumption of lubricant.

In such a situation, various studies have been conducted on piston rings that reduce friction force as well as reduce consumption of lubricant, and Patent Literature 1 suggests a piston ring having fine dimples on its outer peripheral sliding surface. In this suggestion, the dimples are so formed on the outer peripheral sliding surface of the piston ring as to reduce a contact area between the outer peripheral sliding surface of the piston ring and an inner wall surface of the cylinder linear, thereby reducing friction force.

Patent Literature 2 suggests a piston ring having plural grooves on its outer peripheral surface, and a piston ring having plural dimples on its outer peripheral surface. In this suggestion, the grooves or the dimples are so formed on its outer peripheral surface as to enhance sliding performance as well as decrease in friction relative to the inner wall surface of the cylinder liner.

### CITATION LIST

### Patent Literature

Patent Literature 1: Japanese Patent Laid-Open 2004-60873
Patent Literature 2: Japanese Patent Laid-Open 2010-38295

### SUMMARY OF INVENTION

### Technical Problem

Unfortunately, in the piston ring suggested in Patent Literature 1, it is not focused on how many dimples are formed, or where the dimples are formed. In the piston ring suggested in Patent Literature 2, although describing how many dimples are formed, Patent Literature 2 only discloses that fewer dimples are formed in the lower portion than in the upper portion, and discusses nothing about other issues such as the area percentage and the dimension of the dimples. For example, if an excessive number of dimples are formed on the outer peripheral sliding surface, friction force, and gas sealing and oil sealing performances are deteriorated, which likely causes scuffing and others.

A main object of the present invention, which has been made in order to solve the problems according to the conventional art, is to provide a piston ring excellent in sliding performance such as scuffing resistance, and capable of satisfying the requirement of low friction of an internal combustion engine with a smaller friction coefficient without deteriorating the performances of the gas sealing and oil sealing.

### Solution to Problem

The present invention for solving the above problems provides a piston ring for an internal combustion engine, mounted in a ring groove of a piston, and sliding against an inner wall surface of a cylinder liner or a cylinder. The piston ring includes plural fine recessed portions formed in a barrel width region of the piston ring on an outer peripheral sliding surface of the piston ring; and a non-recessed portion area where no recessed portions are formed in the barrel width region, the non-recessed portion area configured to have an area percentage within a range from 20 to 85% in the barrel width region where an area percentage of the barrel width region before the recessed portions are formed is defined to be 100%. The non-recessed portion area exists through an entire cross section in an axial direction of the barrel width region.

In this piston ring, in a state where the piston ring is mounted in the ring groove of the piston, and the piston is put in the cylinder, if each straight line between a central axis of the cylinder and each outer peripheral edge of a gap is defined as a reference line, no recessed portions may be formed in an area of the barrel width region defined by an angle of less than 1° tilted around the central axis relative to each reference line.

In this piston ring, a hard anodic oxidation coating may be formed on the non-recessed portion area.

In this piston ring, the recessed portions may be formed not to extend across a lower edge in the axial direction of the outer peripheral sliding surface, and if the lower edge of the piston ring is chamfered, the recessed portions may be formed not to extend across the chamfered portion.

### Advantageous Effects of Invention

According to the piston ring of the present invention, the recessed portions are formed in the barrel width region such that the area percentage of the non-recessed portion area is within the above range, thereby sufficiently satisfying the requirement of low friction. In addition, the non-recessed portion area exists through the entire cross section in the axial direction of the barrel width region, thereby preventing deterioration of performances of gas sealing and oil sealing.

### BRIEF DESCRIPTION OF DRAWINGS

FIG. 1 is a schematic cross sectional view explaining a barrel width region of a piston ring of the present invention.

FIG. 2 is an enlarged perspective view showing the vicinity of a gap of the piston ring when viewed from the outer periphery of the piston ring of the present invention.

FIG. 3 is a schematic development view showing the vicinity of a gap of the piston ring when viewed from the outer periphery of the piston ring of the present invention.

FIG. 4 is a schematic development view showing the vicinity of the gap of the piston ring when viewed from the outer periphery of the piston ring of the present invention.

FIG. 5(a) is a schematic view showing a relation between a cylinder central axis O and a central angle, and FIG. 5(b) is a schematic development view showing the vicinity of the gap of the piston ring where no recessed portions are formed in an area defined by a central angle of less than 1° in the barrel width region when viewed from the outer periphery of the piston ring of the present invention.

FIG. 6 is a schematic development view showing the vicinity of the gap of the piston ring where the recessed portions are formed through an entire outer peripheral sliding surface when viewed from the outer periphery of the piston ring of the present invention.

FIG. 7 is a schematic development view showing the vicinity of a lower edge of the piston ring when viewed from the outer periphery of the piston ring of the present invention.

FIG. 8 is a schematic development view showing examples of shapes of the recessed portion formed on the piston ring of the present invention.

FIG. 9(a) and FIG. 9(b) are a schematic development view and a schematic cross sectional view, respectively, explaining a size and a position of the recessed portion formed on the cylinder of the present invention.

FIG. 10 is a schematic view showing apertures of a masking plate used in Examples of the present invention.

FIG. 11 is a schematic cross sectional view showing a configuration of an apparatus used for measuring reciprocating friction in Examples of the present invention.

FIG. 12 is a graph showing a measurement result in Examples of the present invention.

FIG. 13 is a graph showing a measurement result in Examples of the present invention.

### DESCRIPTION OF EMBODIMENTS

The piston ring of the present invention is a piston ring for an internal combustion engine, which is mounted in a ring groove of a piston and slides against an inner wall surface of a cylinder liner or a cylinder; plural fine recessed portions are formed in a barrel width region of the piston ring on the outer peripheral sliding surface of the piston ring; a non-recessed portion area where no recessed portions are formed in the barrel width region is configured to have an area percentage within a range from 20 to 85% in the barrel width region where an area percentage of the barrel width region before the recessed portions are formed is defined to be 100%; and the non-recessed portion area exists through an entire cross section in an axial direction of the barrel width region.

The barrel width region of the piston ring in the present

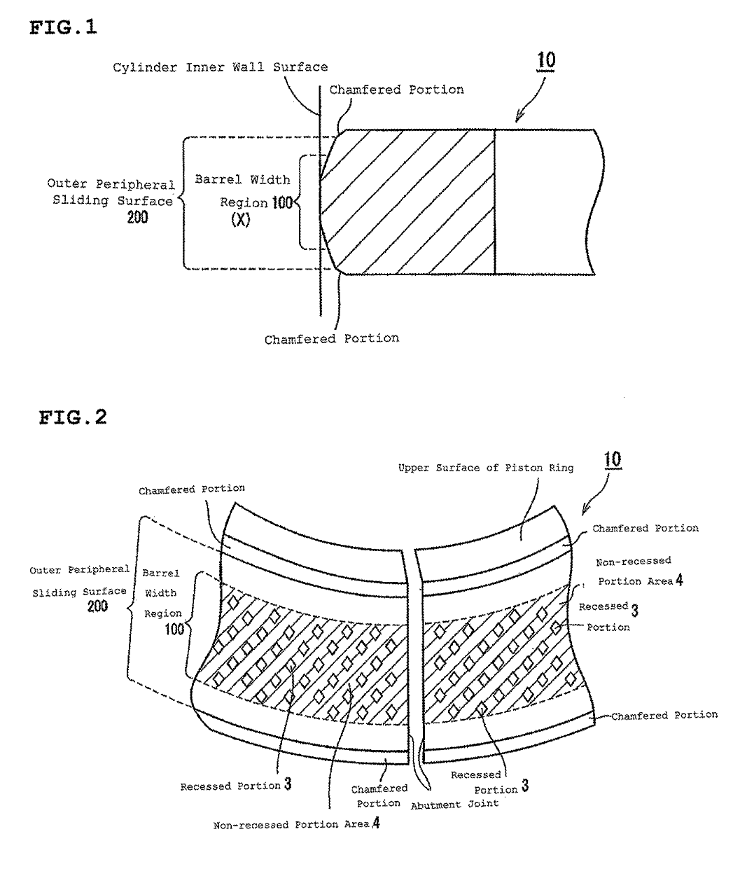

invention denotes the reference sign h8 specified in JIS B 8032-6 (1998). In the case of a barrel face rectangular ring as shown in FIG. 1, the barrel width region 100 is not always formed through an entire outer peripheral sliding surface 200, a portion X on the outer peripheral sliding surface 200 shown in the drawing is the barrel width region 100. FIG. 1 is a schematic cross sectional view explaining the barrel width region 100 of the piston ring 10. Hereinafter, the present embodiment will be described by mainly using an example of a piston ring having the outer peripheral sliding surface 200 in a barrel shape whose upper and lower edges in the axial direction of the outer peripheral sliding surface are chamfered, but the present invention is not limited to this.

The material for use in a body of the piston ring of the present invention is not limited to specific material, and any material may be used for this. For example, steel (steel material) may be mainly used as the material of the piston ring, and as stainless steel material, SUS440, SUS440B, SUS410, SUS420, SUS304 and the like may be used, or 8Cr steel, 10Cr steel, SWOSC-V and SWRH materials may be used. Steel materials subjected to nitriding may also be used. Regarding the type of the piston ring, the piston ring of the present invention may be used not only for a top ring functioning as a compression ring, but also for a second ring also functioning as a compression ring.

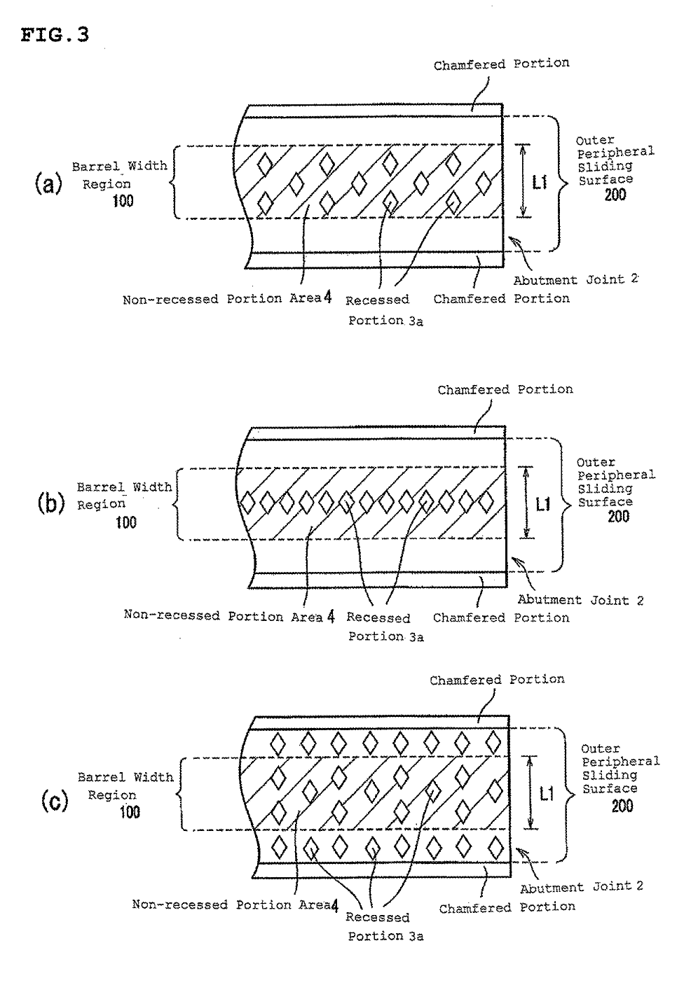

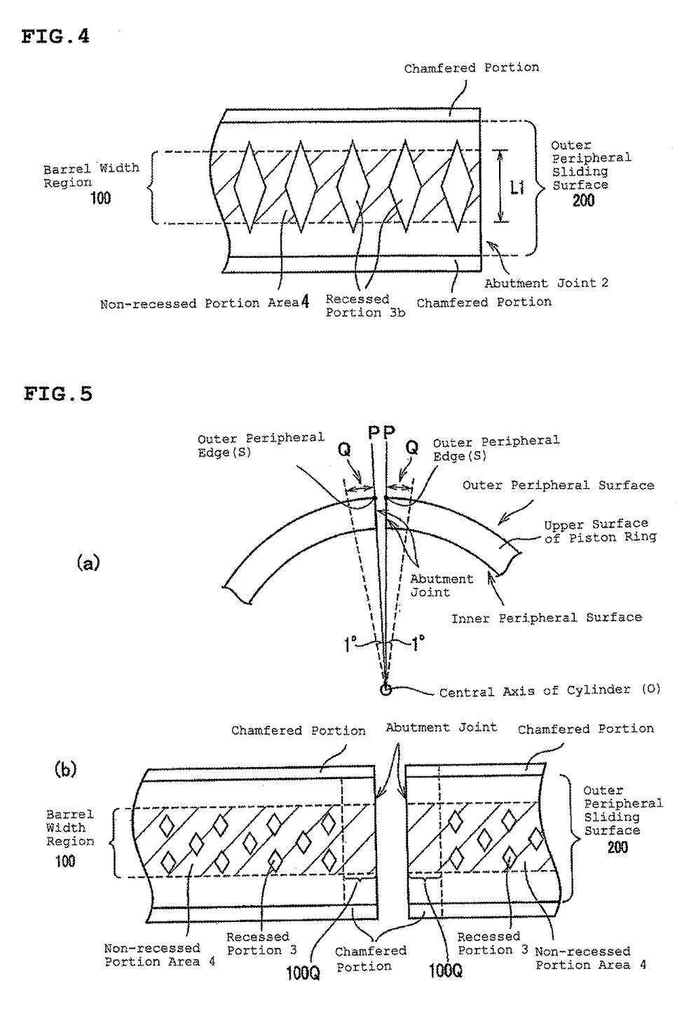

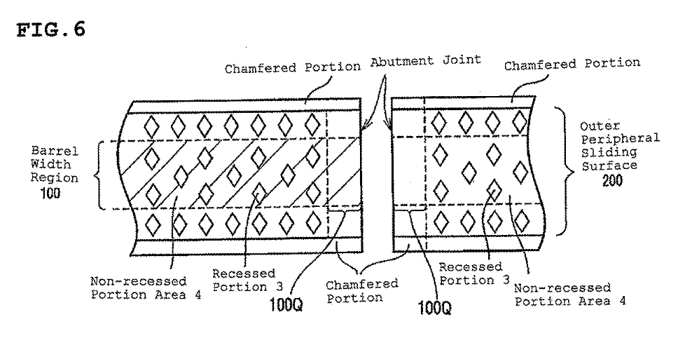

With reference to FIG. 2 to FIG. 4, description will be provided on recessed portions 3 formed in the barrel width region 100 of the piston ring of the present invention. FIG. 2 is an enlarged perspective view showing an example of the vicinity of a gap when viewed from the outer periphery of the piston ring of the present invention, and FIG. 3 and FIG. 4 are schematic development views showing one example of the vicinity of the gap of the piston ring when viewed from the outer periphery of the piston ring of the present invention.

As shown in FIG. 2, there are formed the plural fine recessed portions 3 in the barrel width region 100 of the piston ring 10 of the present invention. This configuration reduces friction force of the reciprocating motion between the piston ring 10 and the inner wall surface of the cylinder liner or the cylinder.

In the piston ring 10 of the present invention, the non-recessed portion area 4 where no recessed portions 3 are formed in the barrel width region 100 is configured to have an area percentage within a range from 20 to 85% in the barrel width region where an area percentage of the barrel width region before the recessed portions are formed is defined to be 100%, and the non-recessed portion area 4 exists through the entire cross section in the ring axial direction of the barrel width region 100. Note that the non-recessed portion area 4 is an area where no recessed portions 3 are formed in the barrel width region 100.

The piston ring 10 of the present invention having the above described features can prevent scuffing and others while maintaining the reduction effect of the reciprocating friction force between the piston ring and the inner wall surface of the cylinder liner or the cylinder. If the area percentage of the non-recessed portion area 4 is less than 20% (the area percentage of the recessed portion area is greater), the contact area becomes too small, so that the contact pressure of the sliding portion becomes significantly increased, which results in increase in the friction force. On the other hand, if the area percentage of the non-recessed portion area 4 is more than 85% (the area percentage of the recessed portion area is smaller), sufficient effect resulted from the formation of the recessed portions 3 cannot be achieved. If the non-recessed portion area 4 does not exist through the entire cross section in the ring axial direction of the barrel width region 100, the sealing performance (airtight performance) becomes significantly deteriorated.

The piston ring 10 of the present invention has an essential requirement that the non-recessed portion area 4 exists through the entire cross section in the ring axial direction of the barrel width region 100, and the plural recessed portions 3 are so formed in the barrel width region 100 as to satisfy this requirement.

The method to satisfy this requirement is not limited to a specific method, and for example, as shown in FIG. 3(a), if the recessed portions 3 are so formed in the barrel width region 100 as to have a shorter length in the ring axial direction than the length in the ring axial direction (L1) of the barrel width region, the non-recessed portion area 4 can be allowed to exist through the cross section in the ring axial direction of the barrel width region 100 regardless of the position where the recessed portions 3 are formed.

FIG. 3(a) shows one example of the piston ring having the recessed portions 3 whose length in the ring axial direction is shorter than the length in the ring axial direction (L1) of the barrel width region, and which are formed through the entire surface of the barrel width region 100, but the configuration of the present invention is not limited to this. For example, as shown in FIG. 3(b), the recessed portions 3 may be intensively formed in an area closer to the barrel summit in the barrel width region 100 within the above described requirement. As far as the recessed portions 3 are so formed in the barrel width region 100 as to satisfy the above requirement, the recessed portions 3 may be formed not only within the barrel width region 100, but also through the entire surface of the outer peripheral sliding surface 200, as shown in FIG. 3(c).

To the contrary, as shown in FIG. 4, if the recessed portions 3b are so formed in the barrel width region 100 as to have a longer length in the ring axial direction than the length in the ring axial direction of the barrel width region 100, even a singular recessed portion 3b extends through the cross section in the ring axial direction of the barrel width region 100, so that the non-recessed portion area 4 cannot exist in the cross section in the ring axial direction of the barrel width region 100, which significantly deteriorates the sealing performance.

The number and the shape of the recessed portions formed in the barrel width region 100 are not limited to specific ones, but the number and the shape of the recessed portions are required to be adjusted such that the non-recessed portion area 4 where no recessed portions 3 are formed in the barrel width region 100 is configured to have an area percentage within a range from 20 to 85% in the entire area of the barrel width region assumed to have no recessed portions 3 therein.

Although it depends on the type of an engine, the recessed portions 3 are preferably formed within a range from 8 to 50% from the barrel summit in the barrel width, more preferably within a range from 8 to 25% thereof. The recessed portions 3 formed at the position closer to the barrel summit achieve sufficient effect of the friction force reduction at the initial sliding stage, thereby controlling the sealing performance between the outer peripheral sliding surface of the piston ring and the inner wall surface of the cylinder. The barrel summit denotes a central portion in the ring axial direction in a symmetric barrel, and a portion where the radial length in the ring axial direction becomes maximum in an eccentric barrel.

As shown in FIG. 5(a) and FIG. 5(b), in a state where the piston ring is mounted to the piston, and this piston is put in the cylinder, if each straight line between the central axis (O) of the cylinder and each outer peripheral edge (S) of the gap is defined as a reference line (P), no recessed portions 3 are preferably formed in an area in the barrel width region (100Q) defined by an angle of less than 1° tilted around the central axis (O) relative to each reference line (P). Forming no recessed portions 3 in this area of the barrel width region (100Q) reduces possibility to cause a problem such as scuffing due to excessive increase in contact pressure at the gap. FIG. 5(a) is a schematic diagram showing a relation of the angles defined by the cylinder central axis (O), the reference line (P), and the reference line (P), and FIG. 5(b) is a schematic development view of the vicinity of the gap viewed from the outer periphery of the piston ring, in which no recessed portions 3 are formed in the area in the barrel width region (100Q) defined by an angle of less than 1° tilted around the central axis (O) relative to each reference line (P) if each straight line between the cylinder central axis (O) and each outer peripheral edge (S) of the gap is defined as the reference line (P).

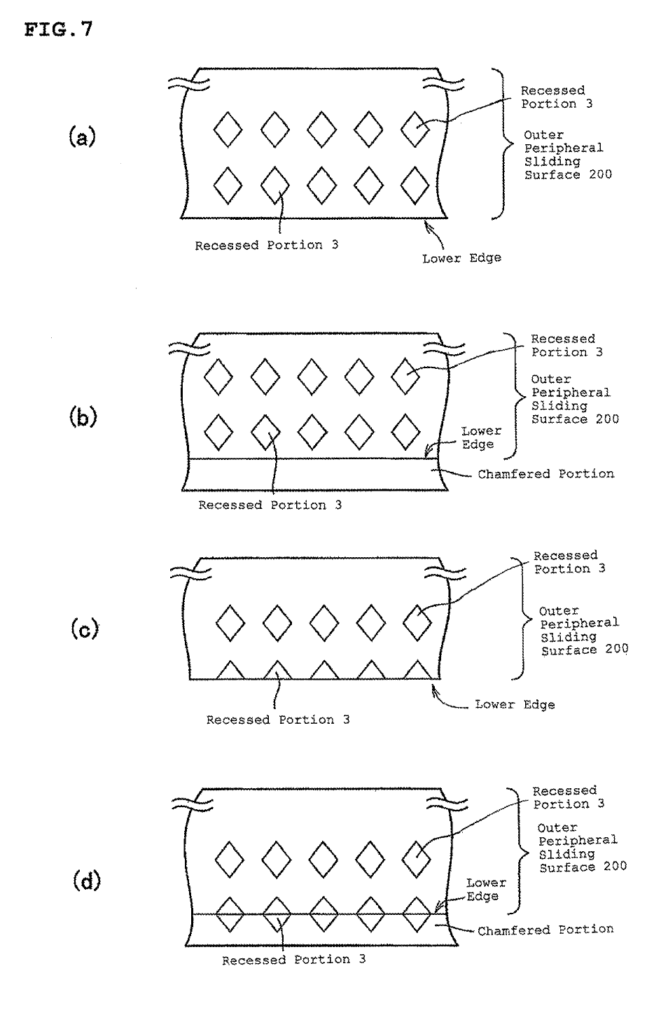

At the time of the piston sliding, combustion pressure is applied onto the upper surface of the piston ring, so that stress concentration likely occurs on the lower surface of the piston ring. If the recessed portions 3 are formed across the lower edge in the axial direction of the outer peripheral sliding surface, as shown in FIG. 7(c), the piston ring likely becomes broken from these recessed portions 3. Taking account of this point, it is preferable to avoid forming the recessed portions 3 across the lower edge in the axial direction of the outer peripheral sliding surface, as shown in FIG. 7(a). In the case of having a chamfered portion in contact with the lower edge of the outer peripheral sliding surface, as shown in FIG. 7(d), if the recessed portions 3 are formed across this chamfered portion, the piston ring likely becomes broken from these recessed portions 3. Taking account of this point, it is preferable to avoid forming the recessed portions 3 across the chamfered portion, as shown in FIG. 7(b). FIG. 7(a) to FIG. 7(d) are schematic development views showing the recessed portions formed in the vicinity of the lower edge in the axial direction of the outer peripheral sliding surface of the piston ring.

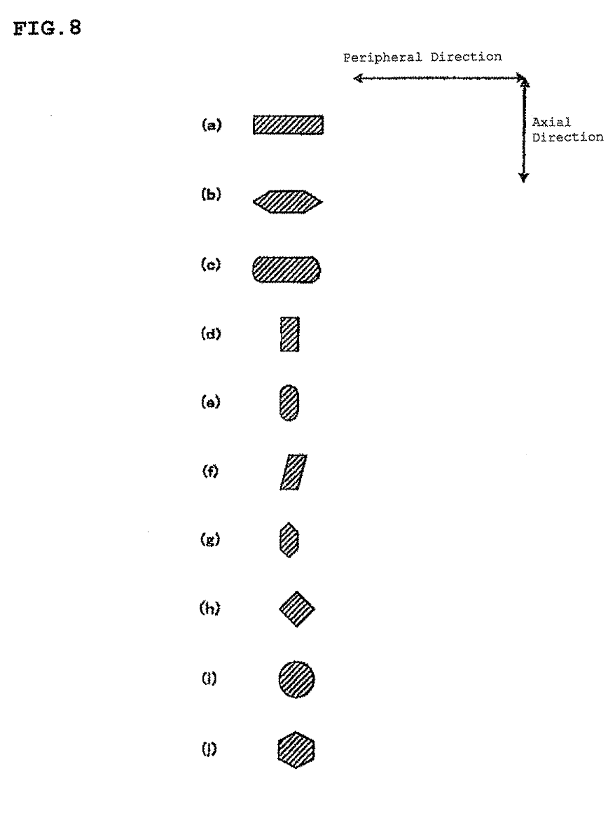

In the present embodiment, the front view shape (plane expanded in the peripheral direction of the piston ring) of recessed portion formed in the barrel width region of the piston ring is not limited to a specific one, and the shape thereof may be appropriately adjusted depending on the arrangement of the recessed portions. For example, as exemplified in FIG. 8(a) to FIG. 8(j), each recessed portion may be formed in a shape made of straight lines and/or curved lines. The recessed portion may be formed in a laterally long shape as shown in FIG. 8(a) to FIG. 8(c), in a vertically long shape as shown in FIG. 8(d) to FIG. 8(g), or in a shape having an aspect ratio of substantially 1:1 as shown in FIG. 8(h) to FIG. 8(j).

The average peripheral length of each recessed portion is preferably within the range from 0.01 mm to 5 mm, more preferably within the range from 0.01 mm to 0.3 mm. If each recessed portion has the average peripheral length less than this range, it may be difficult to achieve sufficient effect of the formation of the recessed portions. To the contrary, if each recessed portion has the average peripheral length more than this range, a trouble such as deformation of the piston ring may be caused.

In the present embodiment, the average radial length of each recessed portion is preferably within a range from 0.1 μm to 100 μm, and more preferably within a range from 0.5 μm to 30 μm. If each recessed portion has the average radial length less than this range, it may be difficult to achieve sufficient effect of the formation of the recessed portions. To the contrary, if each recessed portion has the average radial length more than this range, it may be difficult to machine the recessed portions, or it may cause a problem that requires increase in the average radial length of the piston ring (increase in the wall thickness). The average radial length of the recessed portion should be appropriately adjusted such that the inner peripheral surface of the recessed portion does not extend beyond the barrel width region.

In the present embodiment, the average peripheral length (average peripheral length of the non-recessed portion area) between two adjacent recessed portions is preferably within a range from 0.1 mm to 15 mm, and more preferably within a range from 0.3 mm to 5 mm. If the average peripheral length (average peripheral length of the non-recessed portion area) between the two adjacent recessed portions is less than this range, stable sliding between the piston ring and the inner wall surface of the cylinder may be hindered. To the contrary, if this average peripheral length between the two adjacent recessed portions is more than this range, it may be difficult to achieve the sufficient effect of the formation of the recessed portions.

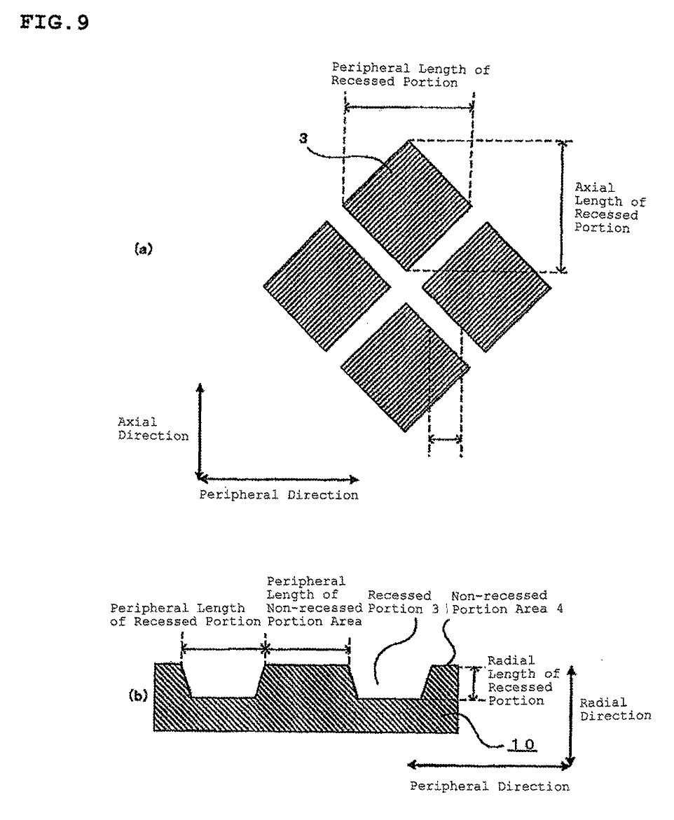

Each average length of the recessed portion in the present embodiment denotes the average length of each part thereof as shown in FIG. 9. FIG. 9(a) is a schematic development view of the axial direction of the piston ring in the barrel width region, which is viewed in the vertical direction of the drawing. FIG. 9(b) is a schematic cross sectional view of the barrel width region in the peripheral direction. The average axial length of the recessed portion denotes the average of the length of the recessed portion in the axial direction of the piston ring, as exemplified in FIG. 9(a).

The average peripheral length of the recessed portion denotes the average of the length of the recessed portion in the cylinder peripheral direction, as exemplified in FIG. 9(a). As exemplified in FIG. 9(b), the average peripheral length of the recessed portion denotes the average of the length of the aperture area formed by the recessed portion.

The average radial length of the recessed portion denotes the average of the length from the bottom of the recessed portion to the non-recessed portion area, as exemplified in FIG. 9(b). The average peripheral length between the recessed portions (average length of the non-recessed portion area) denotes the average of the interval between the adjacent recessed portions, as exemplified in FIG. 9(a) and FIG. 9(b).

In the present embodiment, in the light of the friction force reduction of the reciprocating motion between the piston ring and the inner wall surface of the cylinder liner, the ten point average roughness (Rz) in the non-recessed portion area 4 is preferably 3.2 μm or less, and more preferably 1.6 μm or less. The ten point average roughness Rz is specified by JIS B0601-1994.

### (Forming Method of Recessed Portions)

The method of forming the recessed portions in the barrel width region of the present embodiment is not specifically limited, and any method may be employed as far as the recessed portions can be formed so as to satisfy the above requirements.

For example, the following methods may be employed: a blast machining method of forming the recessed portions by blasting abrasive grains after applying the masking; a method of forming the recessed portions by soaking the piston ring in a corrosive solution after applying the masking; or a corrosion treatment method of using a corrosive solution instead of using a ink in the relief printing.

A hard anodic oxidation coating may be formed on the barrel width region of the piston ring with the hard anodic oxidation coating processing such as various PVD methods and CVD methods, and thereafter, the recessed portions are formed in the aforementioned manner. In this method, the hard anodic oxidation coating is formed on the non-recessed portion area 4, thereby enhancing the wear resistance of the non-recessed portion area 4. As the hard anodic oxidation coating, a PVD coating or a CVD coating may be formed, or a DLC (diamond-like carbon) coating may be formed on the PVD coating or the CVD coating, and thereafter the recessed portions may be formed in the aforementioned manner. The DLC coating has low-friction property, and thus this coating further reduces the friction force.

In the piston ring of the present embodiment, the recessed portions may be consequently formed in the barrel width region, and the recessed portions may not always be formed by removing the surface of the piston ring in the producing step. Conversely, protruding portions (the non-recessed portion area 4) may be formed on the surface of the piston ring, and as a result, portions other than the protruding portions (the non-recessed portion area 4) may be used as the recessed portions. Specifically, in this case, after a predetermined masking is applied, the hard anodic oxidation coating may be so formed as to be the protruding portions (the non-recessed portion area 4) with various PVD methods and CVD methods.

### (Surface Treatment in the Non-Recessed Portion Area)

As aforementioned, the formation of the recessed portions in the barrel width region 100 increases the outer peripheral contact pressure of the piston ring, which encourages wear on the peripheral surface of the piston ring. The friction force likely becomes increased at a top dead center stop position and a bottom dead center stop position during the reciprocating movement of piston ring. Taking into account of this points, the surface treatment is preferably applied to the non-recessed portion area 4 so as to reduce the friction force on the outer peripheral surface of the piston ring, and reduce the friction force at the top and bottom dead center stop positions. An example of such a surface treatment may include a method of forming on the non-recessed portion area 4 a DLC (diamond-like carbon) coating having wear resistance and low friction property as the hard anodic oxidation coating, or a PVD coating having high wear resistance. In the present invention, it is particularly preferable to provide such a treatment that forms a Cr—Ni based or Ti—Ni based PVD coating on the non-recessed portion area 4, and further forms a DLC coating on this PVD coating. The sliding surface of the barrel width region 100 gradually expands in the radial direction due to the piston sliding motion, and thus it is preferable to apply the above surface treatment on the outer peripheral sliding surface 200, as well. This treatment is unnecessary if the recessed portions are formed after the hard anodic oxidation coating is formed on the barrel width region of the piston ring, or the protruding portions (the non-recessed portion area 4) are formed with the hard anodic oxidation coating, as described above.

### (Surface Treatment of Inner Peripheral Surface of Recessed Portion)

The lubricant oil is retained in the inner peripheral surface of each recessed portions during the sliding motion. If the lubricant oil retained in the inner peripheral surface of the recessed portions becomes oxidatively degraded, soot mainly including carbon is generated, and the generated soot adheres to the inner peripheral surface of the recessed portions, and then further soot is gradually accumulated on the soot adhering to the inner peripheral surface of the recessed portions, serving as the accumulation base. If the accumulated soot causes clogging to the recessed portions, the contact area between the piston cylinder and the cylinder liner becomes increased, so that the reduction effect of the reciprocating friction achieved by the formation of the recessed portions cannot be maintained for a long term.

Taking into account of this point, it is preferable to apply such a surface treatment to the inner surface of the recessed portions that prevents the lubricant from being retained on the surface of the recessed portions for a long term. An example of such a surface treatment may include a method of coating resin having oil repellency property, or a phosphate conversion coating treatment to generate a phosphate film on the inner surface of the recessed portions. The phosphate conversion coating treatment is a chemical treatment to chemically generate a phosphate film on a metal surface using phosphate treatment liquid. An example of the resin having the oil repellency property may include fluororesin or the like, for example.

### Example

Further specific explanation will be provided on the present invention by describing Examples and Comparative Examples, hereinafter.

Piston rings were so machined as to have the recessed portions in the barrel width region in the following method.

### <Machining of Piston Ring>

### (Preparation of Piston Ring Before Machining)

Piston rings before no recessed portions were formed were prepared in the following condition.

Material: SUS410J1

Shape: Barrel shape

Outer diameter (D): 95.4 mm

Axial height (h1): 2 mm

Radial width (a1): 2.55 mm

Cut-out at upper and lower chamfered portions: 0.2 mm

Axial length of barrel width region 100: 1.2 mm

Each piston ring was gas-nitrided at a temperature of 550° C. for five hours, and thereafter a Cr—B—N coating was applied to its outer peripheral sliding surface. The Vickers hardness was 1800 Hv (0.1).

### (Preparation of Masking Plate)

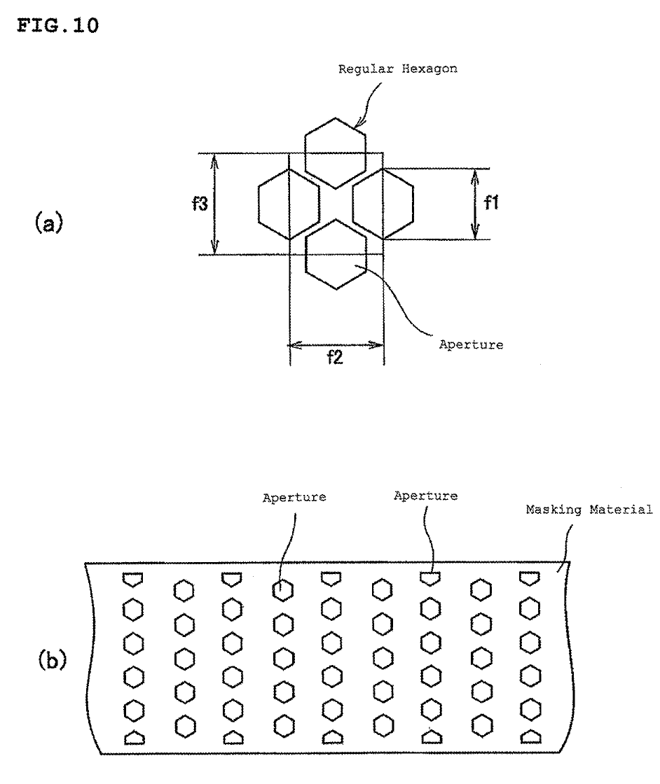

There were prepared masking plates 1 to 7 having apertures each of which has a hexagonal shape as shown in FIG. 10(a) in the dimensions shown in Table 1 below. Each of the masking plates 1 to 7 used herein was made of S45C, and had a thickness of 0.1 mm. In each of the masking plates 1 to 7, in a state where the piston ring is mounted to the ring groove of the piston, and this piston is put in the cylinder, if each straight line between the central axis of the cylinder and each outer peripheral edge of the gap is defined as a reference line, the apertures are formed in an area other than an area in the barrel width region defined by an angle of less than 5° tilted around the central axis relative to each reference line.

TABLE 1

| | Dimension (mm) | | |
|---|---|---|---|
| | f1 | f2 | f3 |
| Masking Plate 1 | 0.19 | 1.1 | 0.57 |
| Masking Plate 2 | 0.19 | 0.82 | 0.57 |
| Masking Plate 3 | 0.19 | 0.25 | 0.29 |
| Masking Plate 4 | 0.19 | 0.21 | 0.29 |
| Masking Plate 5 | 0.19 | 1.76 | 0.29 |
| Masking Plate 6 | 0.19 | 0.19 | 0.29 |
| Masking Plate 7 | 1.3 | 0.24 | 0.99 |

### (Formation of Recessed Portions)

(1) A work was prepared in such a manner that spacer rings and the piston rings before their outer peripheral sliding surfaces were machined in the above manner were alternatively fit around a tube, and the outer periphery of the piston ring was wrapped with the masking plate 1. Thereafter, a fixing ring was put around the outer periphery of the masking plate so as to fix the masking plate and prevent its displacement. In this example, the masking plate was set between the spacer ring and the fixing ring.
(2) The work was set on a turn table of the blast machining apparatus, and was blast-machined on the masking plate in the following condition, thereby forming the recessed portions.

### <Machining Condition>

Abrasives material: Alumina

Blast pressure: 0.1 MPa

Rotational frequency of work: 298 rpm

Distance between gun and work: 40 mm

Vertical-feed speed of gun: 164 mm/min

Blast diameter of gun: 8 mm

Reciprocation cycle of gun: 3

Blast time: 8 min

(3) The work was removed from the turn table, and the masking plate was removed, and the piston ring to which the recessed portions were formed was then removed from the tube. A piston ring having the recessed portions formed through this masking plate 1 was used as the piston ring for the Example 1.
(4) The above (1) to (3) steps were also carried out in the case of the masking plates 2 to 7. Piston rings to which the recessed portions were formed through the masking plates 2 to 4 were used as the respective piston rings for Examples 2 to 4. A piston ring to which no recessed portions were formed was used for Comparative Example 1. Piston rings to which the recessed portions were formed through the masking plates 5 to 7 were used as the respective piston rings for Comparative Examples 2 to 4.

In each of the piston rings of Examples 1 to 4 and Comparative Examples 2 and 3, the recessed portions were formed such that the center of an area of the recessed portions was located at the center of the axial width of the barrel width region, and each recessed portion had a hexagonal shape, and each recessed portion had an axial length of 0.19 mm, a peripheral length of 0.16 mm, and a radial length of 10 μm. Specifically, in each of the piston rings for Examples 1 to 4, and Comparative Examples 2 and 3, the recessed portions were so formed as not to extend through the barrel width region (the non-recessed portion area existed through the entire cross section in the ring axial direction of the barrel width region). The dimension of the recessed portion is an average value of measured values for any five recessed portions.

In the piston ring for Comparative Example 4, the recessed portions were formed such that the center of an area of the recessed portions was located at the center of the axial width of the barrel width region, and each recessed portion had a hexagonal shape, and each recessed portion had an axial length of 1.30 mm, a peripheral length of 0.16 mm, and a radial length of 10 μm. Specifically, in the piston ring for Comparative Example 4, the recessed portions were so formed as to extend through the barrel width region.

### (Measurement of Area Percentage of Non-Recessed Portion Area)

Measurement was conducted on the area percentage of the non-recessed portion area having no recessed portions in the barrel width region where an area percentage of the barrel width region before the recessed portions were formed was defined to be 100%. In a state where the piston ring is mounted in a ring groove of the piston, and this piston is put in the cylinder, if each straight line between the central axis of the cylinder and each outer peripheral edge of the gap is defined as a reference line, no recessed portions were formed in an area in the barrel width region defined by an angle of less than 5° tilted around the central axis relative to each reference line.

### <Measurement Result>

The area percentage of the non-recessed portion area having no recessed portions in the barrel width region, where the area percentage of the barrel width region before the recessed portions were formed was defined to be 100%, was 90% in the piston ring for Comparative Example 2, 85% in the piston ring for Example 1, 80% in the piston ring for Example 2, 50% in the piston rings for Example 3 and Comparative Example 4, 20% in the piston ring for Example 4, and 15% in the piston ring for Comparative Example 3. The area percentage of the non-recessed portion area in the piston ring for Comparative Example 1 (the piston ring having no recessed portions) was 100%.

### (Experiment 1)

### <Measurement of Reciprocating Friction Force>

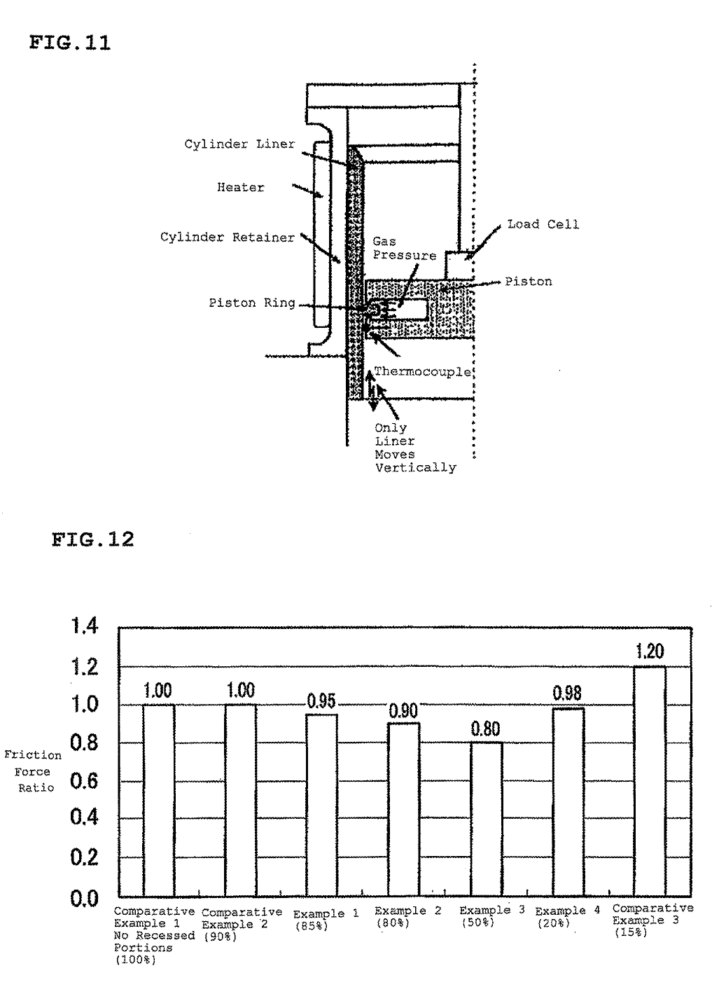

The reciprocating friction force (N) of each of the piston rings for Examples 1 to 4 and Comparative Examples 1 to 3 were measured by using an apparatus shown in FIG. 11. The measurement result of the reciprocating friction forces thereof are shown in FIG. 12. Each friction force ratio is shown in FIG. 12, where the friction force of the conventional piston ring having no recessed portion (the piston ring for Comparative Example 1 (the area percentage of the non-recessed portion area is 100%)) is defined to be 1.00. The rotational frequency during measuring the reciprocating friction force was 700 rpm, the ambient temperature around each piston ring was 80° C., and an oil with SAE viscosity of 10W-30 was used as the supply oil.

### (Experiment 2)

### <Blowby-Gas Test>

Following Experiment 1, the piston rings were mounted to a real machine so as to conduct a blowby-gas test. Specifically, a diesel engine having the following specification was used as a real machine: the displacement was 3000 cc, the number of cylinders was 4, the cylinder diameter was 95.4 mm, the stroke was 104.9 mm. The rotational frequency was set at 3600 rpm, and the water temperature was set at 80° C.

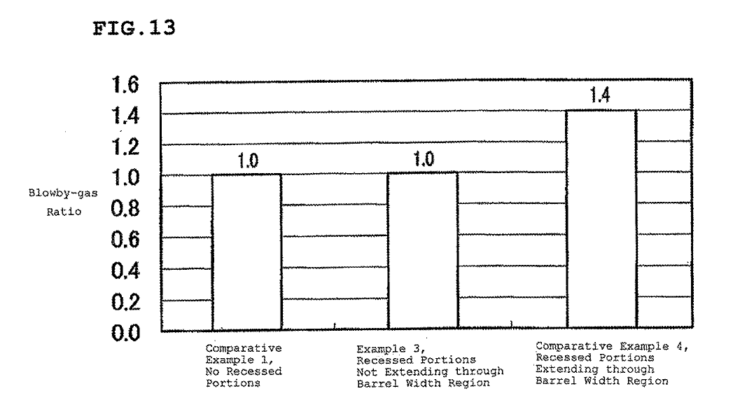

The piston ring was constituted by three rings, and the piston rings for Example 3 and Comparative Example 4 were used as the first compression ring, a taper undercut ring was used as the second compression ring, and a two-piece oil ring including a coil expander and an oil ring body was used as the oil ring. FIG. 13 shows the measurement result of the blowby-gas test in which the piston rings for Example 3 and Comparative Example 4 were used as the first compression ring. FIG. 13 shows each ratio of blowby-gas quantity relative to the blowby-gas quantity of a conventional piston ring having no recessed portions (the piston ring for Comparative Example 1), which was defined to be 1.

As obvious in FIG. 12, it is found that the piston ring having the non-recessed portion area whose area percentage in the barrel width region is out of the range from 20 to 85% where the area percentage of the barrel width region before the recessed portions were formed is defined to be 100% cannot achieve the reduction effect of the friction force.

As obvious in FIG. 13, it is found that in the piston ring having the recessed portions extending through the barrel width region (no non-recessed portion area exists through the entire cross section in the ring axial direction of the barrel width region), the blowby-gas quantity becomes increased.

As the results of Experiments 1 and 2, it is found that it is preferable to adjust the area percentage of the non-recessed portion area 4 having no recessed portion in the barrel width region to be within the range from 20 to 85% where the area percentage of the barrel width region before the recessed portions are formed is defined to be 100%, and it is also preferable to adjust the non-recessed portion area to exist through the entire cross section in the ring axial direction of the barrel width region.

Needless to say that the present invention is not limited to the aforementioned Examples. For example, in the aforementioned Examples, the blast machining method was used for forming the recessed portions, but the present invention is not limited to this, and a method of using a corrosive solution may be employed for forming the recessed portions, instead. In the aforementioned Examples, the masking plates were used, but the present invention is not limited to this, and masking sheets made of resin may be employed, instead.

### REFERENCE SIGNS LIST

2 Gap
3 Recessed portion
4 Non-recessed portion area
10 Piston ring
100 Barrel width region
200 Outer peripheral sliding surface

1. A piston ring for an internal combustion engine, mounted in a ring groove of a piston and sliding against an inner wall surface of a cylinder liner or a cylinder, the piston ring comprising:
plural fine recessed portions formed in a barrel width region of the piston ring on an outer peripheral sliding surface of the piston ring; and
a non-recessed portion area where no recessed portions are formed in the barrel width region, the non-recessed portion area configured to have an area percentage within a range from 20 to 85% in the barrel width region where an area percentage of the barrel width region before the recessed portions are formed is defined to be 100%,
the non-recessed portion area existing through an entire cross section in an axial direction of the barrel width region.

2. The piston ring according to claim 1, wherein
in a state where the piston ring is mounted in the ring groove of the piston, and the piston is put in the cylinder,
if each straight line between a central axis of the cylinder and each outer peripheral edge of a gap is defined as a reference line,
no recessed portions are formed in an area of the barrel width region defined by an angle of less than 1° tilted around the central axis relative to each reference line.

3. The piston ring according to claim 1, wherein
a hard anodic oxidation coating is formed on the non-recessed portion area.

4. The piston ring according to claim 1, wherein
the recessed portions are formed not to extend across a lower edge in the axial direction of the outer peripheral sliding surface.

5. The piston ring according to claim 4, wherein
if the lower edge of the piston ring is chamfered, the recessed portions are formed not to extend across the chamfered portion.

6. The piston ring according to claim 2, wherein
a hard anodic oxidation coating is formed on the non-recessed portion area.

7. The piston ring according to claim 2, wherein
the recessed portions are formed not to extend across a lower edge in the axial direction of the outer peripheral sliding surface.

8. The piston ring according to claim 3, wherein
the recessed portions are formed not to extend across a lower edge in the axial direction of the outer peripheral sliding surface.

9. The piston ring according to claim 6, wherein
the recessed portions are formed not to extend across a lower edge in the axial direction of the outer peripheral sliding surface.
